(19) United States
(12) Patent Application Publication
(10) Pub. No.: US 2019/0188779 A1
(43) Pub. Date: Jun. 20, 2019

(54) Systems and Methods for Distributing Products' Information

(71) Applicant: Ha X. Nguyen, Algonquin, IL (US)

(72) Inventor: Ha X. Nguyen, Algonquin, IL (US)

(21) Appl. No.: 16/226,586

(22) Filed: Dec. 19, 2018

Related U.S. Application Data
(63) Continuation-in-part of application No. 16/184,978, filed on Nov. 8, 2018.
Application No. 16/184,978 is a continuation-in-part of application No. 16/195,734, filed on Nov. 19, 2018.
(60) Provisional application No. 62/607,914, filed on Dec. 19, 2017.

(51) Int. Cl. G06Q 30/06; G06Q 10/08

(52) U.S. Cl. CPC G06Q 30/0641; G06F 3/0482; G06Q 10/083

(57) ABSTRACT

A system for distributing products information an associated methods are disclosed. The product information system having a network connected to the product information system, the network connected to customer devices, store devices, manufacturer devices and at least one workplace, wherein product information is transmitted from the customer devices, store devices, and manufacturer devices to the product information system through the network, wherein the product information system is in communication with the at least one workplace, the at least one workplace having at least one workstation device, and wherein the at least one workstation device is capable of displaying and interacting with the processed product information.

### RELATED APPLICATIONS

This application claims the benefit of provisional application 62/607,914 filed 19 Dec. 2017 and the benefit of U.S. nonprovisional application Ser. No. 16/184,978 filed 8 Nov. 2018; and U.S. application Ser. No. 16/195,734 filed 19 Nov. 2018.

### FIELD OF THE INVENTION

The present invention generally relates to an invention in the field of service and products management. More particularly, this invention disclosed herein relates to the field of devices and methods that are used for managing and distributing product information for service providers.

### BACKGROUND

Manufacturer, retailers, and service providers provide a huge amount of production information to end users. Their information distribution channels include radio and television broadcasters such as CNN, Fox, CBS; internet providers such as Facebook, Google, Yahoo; their own marketing team; etc. Their objective is to distribute product information to all customers efficiently and effectively. However, in reality many resources and monies are wasted, because the end users do not have the appropriate product information as needed. In the beauty business, in particular, clients do not have enough product information when they are at the salons for services.

For example, information of a polish they picked for a pedicure is nothing more than those texts printed in very small fonts on the polish bottle. Nothing else is typically provided, and the information is not up-to-date. Customers typically want to know more information about products (polishes, acrylic power, chemicals) applied on them. Lack of product information may result in unhappy customers and lack of repeat business.

Another issue with current practices is that customers change their selections of services all the time—before, during, and after their selected service finished. This significantly increases the headache of serving a mercurial customer. In nail service, for example, customers usually select a polish before their pedicure service starts. When in a spa chair and being served, customers may not change her previously selected polish, because the polish station is in the reception area and the technician is performing the service on her. If the customer really wanted to change her selected polish to a different one: her technician must stop, she has to get out of the workstation she is on, and she has to go to the polish station at the reception area for a different polish.

Currently, many nail salons have no other ways to serve their customers better. They knew that it is very expensive and time consuming if they stopped in the middle of performing a service due to customers' changes of previously selected services and/or products. In addition, the nail industry is well populated by people who do not speak English as their native language, so communication with customers can be a problem.

In another issue for nail service providers, customers have less choices than the actual available polishes to choose from for their nails. All available polishes are displayed on the shelves in the reception area. After selecting a desired polish, the customer take it with them to the servicing workstation, leaving one polish less on the shelves. When a subsequent customers comes in, they have fewer options of polishes on the shelves to choose from until it is returned.

In the beauty business, there are thousands of products available. For example, there are thousands of different types of polishes available, and it is very hard for customers and servers to differentiate the colors of polishes. For example, if a client comes back for a nail service and asks for the same color of her current polish on her nails it will be difficult to find the exact match by simply comparing. Thus, the nail service providers currently use a method to facilitate their service operation: numbering. However, there is an issue: the same number is used by more than one manufacturer, resulting in confusion. As a result, nail service owners have to manually re-assign a number to each of every beauty products they use in their salons. For example, they write a number 1 to the red polish, number 2 to the pink polish, number 3 to the green polish, number 4 to the beach dipping powder, and so on. They have to do this manually, as well as maintain records. The problem in doing this is that it takes a lot of time and there are a lot of errors in manually numbering the new products and the existing products.

In addition, the numbering method helps nail salons finding products (polishes, dipping powers, etc.) more easily. For example, they wrote a same number on the polish bottle, on the polish's placeholder on the display shelf, and on the polish's samples. Customers use polish's samples to select a color. Nail technicians, then, use the number written on the polish's sample to find the polish on the display by matching the number. The problem here is that the polishes are not on their placeholder on the display all the time because after used, the used polishes are not placed back to their assigned location; nail technicians all the time spend a lot of time looking for polishes.

Thus, to summarize, there are several problems that beauty and massage salons face daily. The problems cause many issues, such as increased time managing products as well as difficulty in changing the business on the fly.

Other inventions and attempts have been made to solve this problem, a survey of which are presented below.

WO2011109879 by Donada discloses a nail polish display and organiser trolley is used to organise nail polish bottles in an optimised manner, enabling different colours to be quickly found and taken from the trolley for use. The trolley comprises a system of casters (2) mounted on a base (1) having a cavity with structural grooves (3), four wings (4) having a curved shape and a reinforcement for carrying the casters (2). The two highest sides (5, 6) comprise a recess into which a handle (7) is fitted. The handle (7) has a round tubular profile (7) that extends vertically from the base, forms a top curve and fits into the other side of the base. The handle (7) also carries a series of stacked shelves (8) at various heights on which the nail polish bottles are arranged. Each of the shelves (8) comprises a plurality of compartments (9) in which the nail polish bottles are placed.

U.S. Pat. No. 3,499,549 by Hubcovsky discloses an invention generally related to storage of cosmetics and the like, and more particularly, to a new and improved organizer for various items of cosmetics to be adaptable to cooperate with a dressing table drawer, medicine cabinet, or the like.

U.S. Pat. No. 6,491,217 by Catan discloses a method and system for reading machine-readable label devices and searching resources bases responsive to the context in which the reading took place provides versatility and intelligence that insures users will obtain real value from their use. For example, the system may be used to obtain information about a product fitted with a transponder. The system goes beyond monolithic information-gathering and transaction automation by exploiting context information and flexible search engine technology and by using natural language parsing to make searching to make creation and maintenance of resource bases more economical.

U.S. Pat. No. 6,636,202 by Ishmael et al discloses an apparatus for converting a visual image into a tactile image. The apparatus comprises imaging means for converting incident light from the visual image into electrical signals that are proportional to the gray scale intensity of the incident light. The apparatus also comprises a tactile display device having a two-dimensional array of variable height pixels, wherein the height of each pixel in the tactile display is dynamically variable in proportion to the electrical signals from the imaging means. Preferably, the height of each pixel is inversely proportional to the gray scale intensity of the incident light so that the maximum height of a pixel occurs when a corresponding pixel in the visual image is black.

U.S. Pat. No. 9,913,523 by Contag discloses a universal nail polish storage and display assembly includes a case having a base and a cover interconnected thereto, the cover having a display frame formed therethrough. A storage unit comprising a storage medium at least partially formed of a resilient material is mounted in the case. The storage medium includes a plurality of storage compartments each dimensioned to receive a different one of a plurality of nail polish containers therein. Each storage compartment has at least one slot disposed in communication therewith such that a portion of a nail polish container which may not fit into the storage compartment itself may be at least partially inserted into the slot such that the remainder of the container fits into the storage compartment. The assembly may be utilized to store and display a plurality of different nail polish containers in an upright operative orientation.

As is seen, current systems and software applications for beauty service business, such as point of sales, operation management, and appointment booking, do not have better methods to deal with the above issues.

Accordingly, there is a need for the present invention of systems and computer implemented methods for distributing product information, the present invention consisting of systems, computer-implemented methods, and computer applications capable of providing end users, retailers, service providers, and manufacturers ability to share product information, facilitate service operations, and make selection of products. The present invention will also increase customer satisfaction, save costs for business owners, and grow their business by allowing customers selecting services and products electronically while the customers are in salons or stores. These features, and others, of the Systems and Methods for Distributing Products' Information are disclosed herein and discussed in greater detail below.

### BRIEF SUMMARY

Currently-available devices, as discussed above, therefore currently do not use a novel system as described herein. This design is both interesting and easily useable, two important features in the modern market.

To resolve the limitations described above, the present invention herein discloses systems and computer-implemented methods for distributing product information to end users, retailers, service providers, and manufacturers. The present invention will provide a completely closed system of sharing production information: bi-direction information sharing systems and methods; product providers may provide product information to customers and the customers may provide feedbacks to the providers. The present invention also facilitates service operations for service providers. This section provides a general summary of the disclosure, and is not a comprehensive disclosure of its full scope or all of its features.

The various embodiments of the present invention herein provided teach how to distribute product information to end users, retailers, service providers, and manufacturers over communication networks such as the Internet and/or cellular.

To allow for distributing product information, various embodiments of the present invention include systems, methods, and computer readable media to facilitate sharing product information by end users, retailers, service providers, and manufacturers. The system, called Product Information System (PIS), is a network of electronic devices including, but not limited to, computer devices such as servers, desktops, laptops, external and internal memory devices, smart mobile phones, handheld tablets, network routers, and database devices with network communication capability for communicating and displaying information of products and business including marketing data. Included in the PIS, processors are coupled with the memory, the communication network interface, the user interface, and the power supply. The memory includes ROMs and RAMs for storing programming instructions. The communication network interface is capable of communicating via a network includes WIFI, Bluetooth, ethernet, and SIM card. The user interface capable of displaying information includes a computer monitor, a mouse, and a keyboard. The devices also contain software applications such as internet browsers (Firefox, Chrome, and IE) provided by third parties and software applications containing computer programming instructions within the PIS for executing methods of the present invention. The systems and the devices are capable of communicating over a network, such as WIFI, Bluetooth, the Internet, and cellular network. The information is transmitted over a network, wireless and/or wired.

In another aspect of the invention, computer applications are written in computer programming languages such as, but not limited to, C, C++, Java, C#, Linux, Unix, JavaScript, Html, Bootstrap, Androids, Object C, and Restful. Operating systems include, but are not limited to, ubuntu, Linux, Red Hat, Windows, iOS. Processors include, but are not limited to, PowerPC, Intel, AMD, Texas Instruments, ARM. Tools for software development include, but are not limited to, Maven, GIT, GitHub, Eclipse, IntelliJ, .Net, Jenkin, DOORs, and Synergy.

Various embodiments of the present invention herein provided teach how to provide customers' electronically making selections of products and services while physically at the service providers' workplace using the systems and the methods disclosed herein.

Various embodiments of the present invention herein provided teach how to electronically find customers' selected products while physically at the service providers' workplace using the systems and the methods disclosed herein.

Products contemplated are goods such as polishes, dipping powders, and acrylic powders. In an embodiment, the products are beauty services such as pedicures and manicures. The information can be: images, video clips, human readable texts and characters. The information may come from employees such as nail technicians of service providers. In an embodiment, the information is stored in computing servers and uploaded to networking system automatically and manually. In an embodiment, the information is stored in external memory devices and uploaded automatically and manually. In an embodiment, the information is uploaded by product manufacturers. In an embodiment, the information is uploaded by end users from a smart mobile phone. In an embodiment, the information is uploaded by retailers. In an embodiment, the information is uploaded by service providers. In an embodiment, manufacturers may notify users about product information. In an embodiment, users are registered and information of the user's products are stored and/or linked in their network servers. In an embodiment, a help-request for a polish may be electronically received from a client physically in a salon, the polish then delivered to the client by an employee. According to embodiments, systems and methods for the present invention are provided, including electronic devices and software applications for providing product information for customers buying goods and services and selecting products they desired.

The product information can be received from a service provider. The nail service provider shopping at a nail supply store may input her items' information into the store device at the store by scanning the items. Received by the device, the information of the items is wirelessly transmitted by over the Internet network to the PIS. The PIS may then associate the information with an archive of the service provider.

The nail service provider may input her product information into the called customer device by scanning the items. Received by the device, the information of the items is wirelessly transmitted by over the Internet network to the PIS. The PIS may then associate the information with an archive of the service provider. The nail service provider may input product information using the reception device. The information is associated with an archive of the owner within a PIS.

The product information can be received from a retailer. The information is associated with an archive of the retailer within a PIS. In an embodiment, the retailer may input information of products into the store device at her store by scanning the products. Received by the device, the information of the items is wirelessly transmitted by over the Internet network to the PIS. The PIS may then associate the information with an archive of the retailer and with archives of service providers who bought products from the retailer. This way the retailer distributed product information to the retailer's customers (service providers, in this case). The product information can be received from manufacturers. The information is associated with archives of product users within a PIS. The users include, but are not limited to, end users, retailers, and service providers. This way the manufacturer distributes product information to its users.

The product information can be received from an end user (client of a service provider). The information is associated with an archive of the end user within a PIS. This way the client shares and provides her product experience and feedbacks to the service providers and manufacturers. The product information is received from a smart mobile device such as Samsung Galaxy Tab A. In an embodiment, the information is received from a USB stick. In an embodiment, the information may be uploaded automatically by an application running in an electronic device. The information may be associated automatically by an application running in an electronic device. A request may be received by the manufacturers. The PIS may automatically send a request for updating product information to the manufacturers (to the manufacturer devices). The manufacturer devices may automatically send a request for uploading product information to the PIS. The manufacturer may send a request to the customers for sharing information of customers' experience. The manufacturer may send the information of the new products to the customers. The retailer may send the advertisements to the customers for the promotions going on. The service provider may send a request to the clients for the customer satisfaction survey. The client at a workstation in a nail salon, while receiving a service, sends a request to the reception desk for the information of the products be applied on her nails. The client at a workstation in a nail salon, while receiving a service, can send a request to the reception desk for the information of another service. The client at a workstation in a nail salon, while receiving a service, can send a request to the reception desk for another service. The nail technician at workstation in a nail salon can send over the PIS a request to her receptionist at the reception desk for a polish for which her client asked for.

The information may be transmitted over a network from a computer device to another one. In an embodiment, the information is transmitted over a network from a computer device to many computer devices. The network can be a WIFI network; the Internet network; a cellular network; a combination of the Internet and WIFI networks; a wiring network using ethernet cables; or a combination of a wireless network and a wiring network.

In accordance with another aspect of the invention, the client may click on a button on a user interface of the PIS for the information of the polish. Accordingly, the content may represent to the client, including images, video clips, and descriptions. In accordance with another aspect of the invention, while in the nail salon, the client may click on a button on a user interface of the PIS for the information of the polish. Then the client may click the yes button. The receptionist may deliver the polish to the client and provide more information of the product. In accordance with another aspect of the invention, the nail technician working at the workstation may click on a button on a user interface of the PIS for the information of the polish. Then the technician may click the yes button. The receptionist may deliver the polish to the technician. This is a way of getting help to workers with simple communication. In accordance with another aspect of the invention, the client may click on a button on a user interface of the PIS for the information of the service. Accordingly, the content may represent to the client, including images, video clips, and descriptions. In accordance with another aspect of the invention, the client may provide product experience and feedbacks to the manufacturers. The client may log into her service provider's website and may click on a button to share her experience on the product. In accordance with another aspect of the invention, the client may provide product experience and feedbacks to the manufacturers in response to a customer satisfactory campaign. The client may log into her service provider's website and may click on a button to share her experience on the product.

In accordance with another aspect of the invention, the product information includes, but is not limited to, images, video clips, descriptions, advertisements, web contents, media files, audio files, and the like. The PIS may present a window user interface as a webpage on Firefox or another browser. The PIS may present a window user interface as a webpage. The PIS may present a window user interface as a webpage on a browser. The PIS may present a window user interface as a webpage on a browser with a dialog box. The PIS may present a window user interface as a webpage on a browser for the owner to upload information of products. The PIS may present a window user interface as a webpage on a browser for the client to share information of products. In an embodiment, the users are customers, services providers, retailers, and manufacturers.

The PIS may send a request to the workstation for the polish a workstation used earlier. The request may include, but is not limited to, an event from clicking a button, a message from the PIS to manufacturer for updating information of products, and the like. In other systems, methods, and/or software applications according to embodiments will be or become apparent to one with skill in the art upon review of the following drawings and detailed description. The preceding embodiments are intended to serve as some examples of the present invention. This invention summary is not meant to be an overview of all inventive subject matter disclosed in the present of the invention. It is intended that all such additional systems, methods, and/or software applications be included within this description, be within the scope of the present invention, and be protected by the present invention's claims.

In a first embodiment the disclosure contemplates a system for distributing products information having a product information system; a network connected to the product information system, the network connected to customer devices, store devices, manufacturer devices and at least one workplace; wherein product information is transmitted from the customer devices, store devices, and manufacturer devices to the product information system through the network; wherein the product information system is in communication with the at least one workplace, the at least one workplace having at least one workstation device; and

wherein the at least one workstation device is capable of displaying and interacting with the processed product information.

In a second embodiment the disclosure contemplates a method for distributing products information involving opening a webpage or app on a device; selecting a station number; selecting a products category; displaying a products panel; selecting a product on the products panel; thereby distributing products information to a product information system.

Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1 is a view of a schematic diagram of a system architecture for practicing various aspects of embodiments of the present invention.

FIG. 2 is a view of one embodiment of a user interface of product color selection of the product information application within the PIS, rendering on a workstation device.

FIG. 3 is an illustration of one embodiment of a user interface of product brands selection of the product information application within the PIS, rendering on a workstation device.

FIG. 4 is an illustration of one embodiment of a user interface of pedicures service selection of the product information application within the PIS, rendering on a workstation device.

FIG. 5 is an exemplary illustration of an embodiment of a user interface for a help message of the product information application.

FIG. 6 is an illustration of an embodiment of a user interface for uploading information for polishes.

FIG. 7 is an illustration of an embodiment of a user interface for sharing information between users and customers.

FIG. 8 is an illustration of an embodiment of the computing devices depicted in FIG. 1.

FIG. 9 is an illustration of an embodiment of the software application in connection with the present invention.

FIG. 10 is a flow diagram of a method for clients selecting products used in the service and for obtaining information of the products.

FIG. 11 is an illustration of an embodiment of a user interface for a method of service providers numbering their products at a retailer's place.

FIG. 12 is a flow diagram of a method of numbering products by the service providers at the retailer's place.

FIG. 13 is a flow diagram of a method of distributing information of product by service providers.

FIG. 14 is an illustration of one embodiment of a user interface for a method of distributing information of product by manufacturers.

FIG. 15 is a flow diagram of a method of distributing information of product by manufacturers.

FIG. 16 is a flow diagram of a method of sharing information of product by clients.

FIG. 17 is a diagram of a sample of polish on which a sample-tracking device is attached; the sample includes a sample color of a polish.

FIG. 18 is a flow diagram of a method of finding a polish selected by customer.

FIG. 19 is a diagram of a polish-tracking device attached onto a polish.

### DETAILED DESCRIPTION

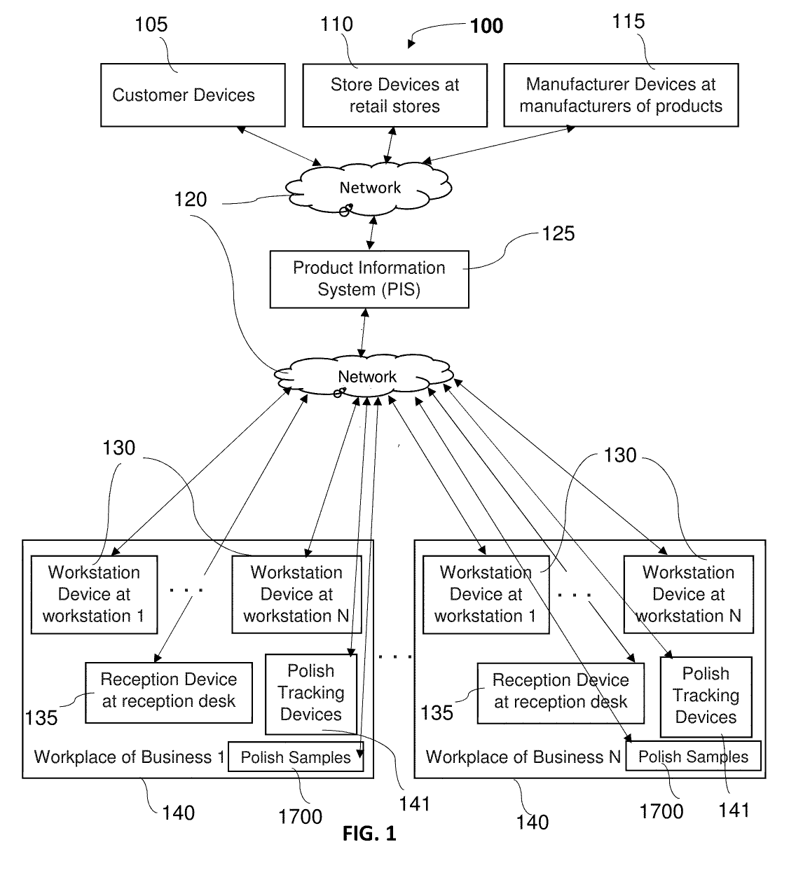

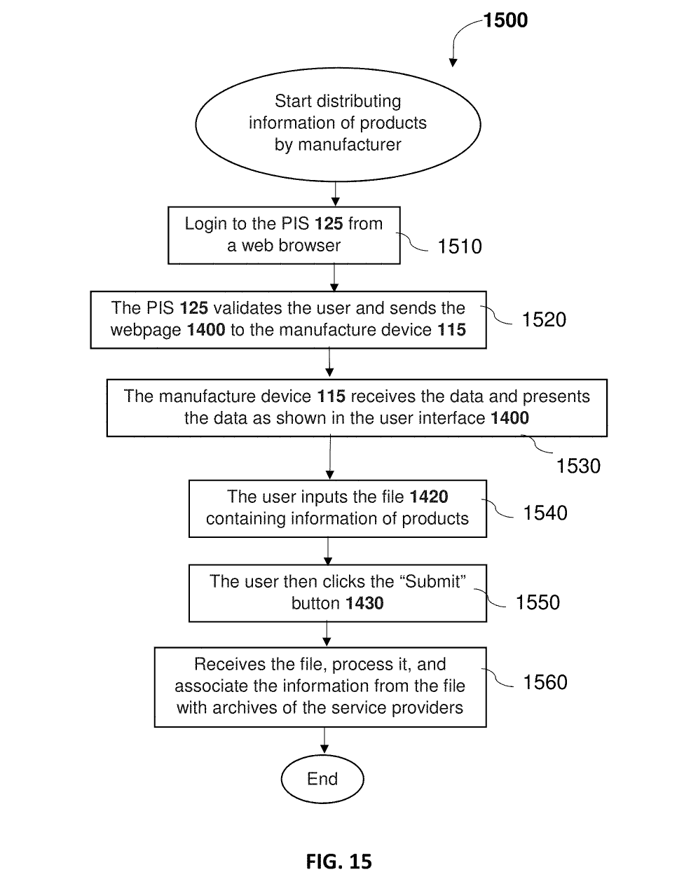

Referring now the drawings with more specificity, the present invention essentially provides systems and methods for distributing products' information. The preferred embodiments of the present invention will now be described with reference to FIGS. 1-16 of the drawings. Variations and embodiments contained herein will become apparent in light of the following descriptions.

Looking now to FIG. 1 there is shown a schematic diagram of a system architecture 100 for practicing various aspects of embodiments of the present invention. The system preferably includes a product information system (PIS) 125, customer devices 105 used by customers and/or any users, store devices 110 located at retailers' workplace, manufacturer devices 115 located at manufacturers' workplace, workstation devices 130 located at service providers' workplace, reception devices 135 located at service providers' workplace, polish-tracking device 141, polish samples 1700 containing sample-tracking device 1730, and communication networks 120. The product information system, PIS, 125 may be a computing server. The manufacturer device 115 may be a computing server. The remaining devices are preferably computers. All devices are preferably internet capable for transmitting information (data) over the network 120, which is the Internet network.

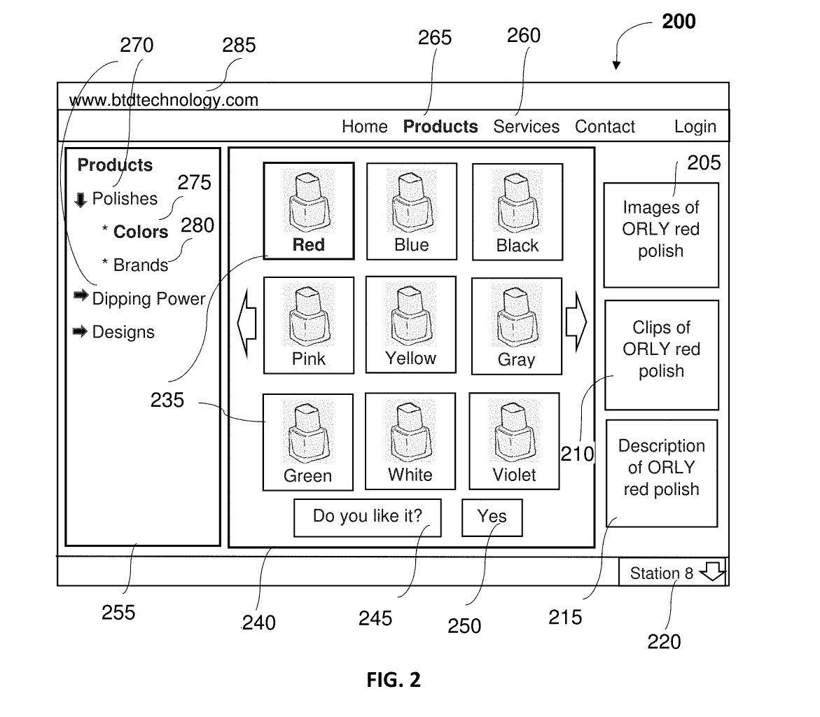

Looking further at FIG. 1, in an embodiment, the product information is transmitted from customer device 105 by customers to the PIS 125 through the network 120.The product information is transmitted from customer device 105 by service providers or customers to the PIS 125 through the network 120. The product information is transmitted from store device 110 by service providers or retailers shopping at the retailer to the PIS 125 through the network 120. The product information is transmitted from manufacturer device 115 by manufacturers to the PIS 125 through the network 120. Upon receiving the information, the PIS 125 may process it, associate it with the appropriate business 140 (service providers), customers, retailers, and manufacturers. When a request (a button 235 clicked as Shown in FIG. 2) for information received from the customer at the workstation 130 of the service provider 140, the PIS may send the information to the workstation 130, and then upon receiving the information, the workstation device 130 may present the information on boxes 205, 210, and/or 215.

In an embodiment, when the request (the yes button 250 clicked) for information of the polish 235 received from the customer at the workstation 130 of the service provider 140, the PIS may send the help message 510 to the reception personnel 135 The PIS may turn the LED 1920 ON of the associated polish-tracking devices 141 and LED 1750 ON of the associated sample-tracking device 1730. Having received the message, the reception device 135 may then present the message 510 on the user interface 500. In this example, the receptionist may identify the polish based on the LED indications from the device trackers and deliver the polish to the client at the workstation 130 and/or provide information of the product to the client.

Looking now to FIG. 2, there is shown a user interface 200 of a workstation device 130 with the support of the web browser 814 within the device 130 and the product information application 960 within the PIS 125. The use interface may be used by clients for obtaining information of desired products. In an embodiment, the user interface 200 may allow the clients to obtain online the information of products. For example one may open the website with the URL 285, the client may click on the Products 265, then click the Polishes 270, then click the Colors 275, then the user interface 200 is displayed. To obtain information of a desired polish 235, the client may just click on the button 235. The information of the polish may be presented on the boxes 205, 210, and 215.

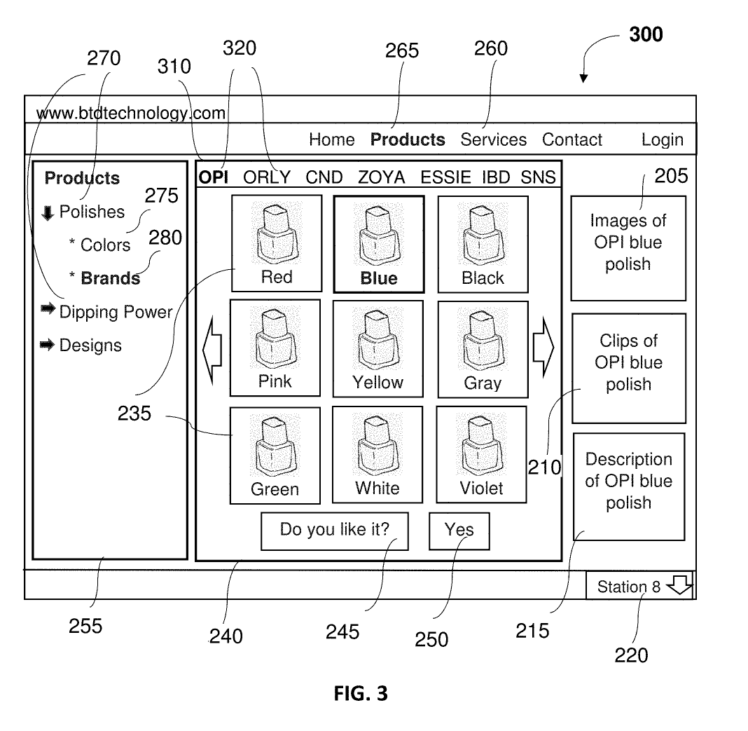

In FIG. 3, an embodiment of the user interface 300 allows the clients to obtain online information about products. Similar to the above Colors 275 case, the Brands 280 is used to obtain information of the polished selected. The user interface 300 may allow the clients to get help from the receptionist. Similar to the above Colors 275 case, the Brands 280 is used to have the desired polish by the receptionist of the salon.

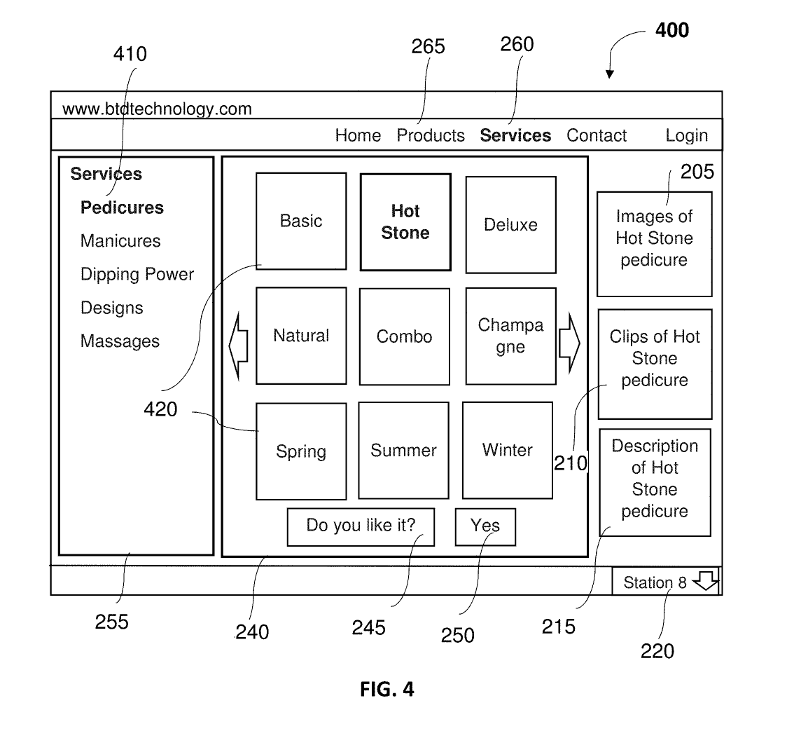

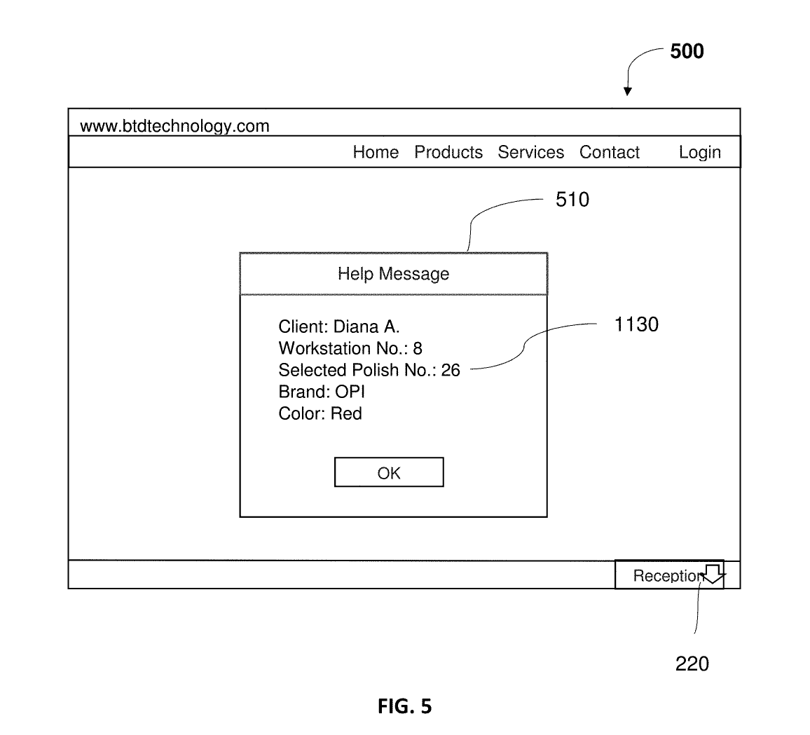

In FIG. 4, an embodiment of the user interface 400 that allows the clients to obtain online information about services is shown. The user interface 400 may allow the clients to get help of services from the receptionist by making some selections, for example: click services 260, click Pedicures 410, click Hot Stone 420, click the yes button 250, the receptionist may appear at the workstation at where the client is to help her, after receiving the help message 510 (as shown in FIG. 5) displayed on her reception device 135.

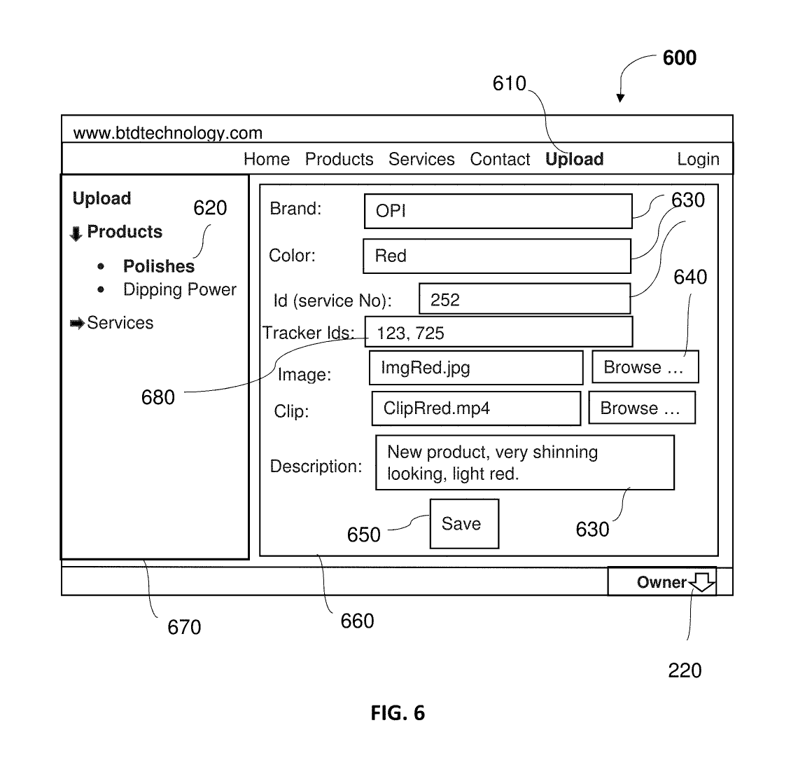

Looking now to FIG. 6 a user interface 600 is shown. The user interface 600 may allow the service providers to upload information of products. To upload information of a product, the salon owner may do the following steps: open the website with the url, select the option Owner 220, click Upload 610, click Products, click Polishes 620, the user interface 600 may be presented. The owner may input all, or part, of information of the product: type brand, color, id, and description into input fields 630, polish and sample device tracker Ids 680, and browse files of image and video clip, and then click Save 650. The information may be transmitted to the PIS 125, which may associate the information with an archive of the service provider. The PIS 125 also links all polish button 235 on user interface, polish-tracking device 141, and sample-tracking device 1730 together for this polish.

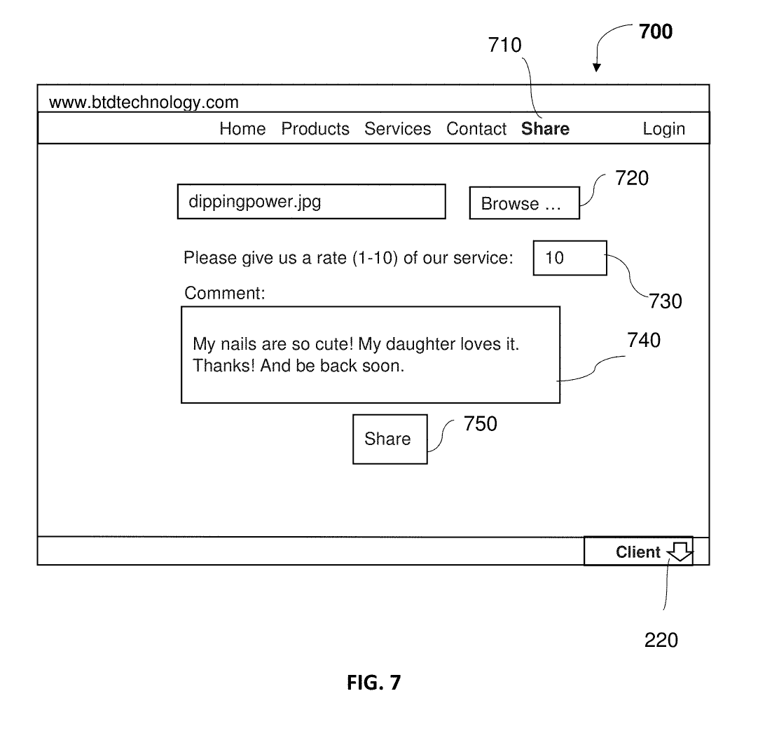

FIG. 7 shows that the user interface 700 may allow the clients to share their product experience and feedbacks to service providers and/or manufacturers. To do this, the clients may just follow these steps: open the website with the url, select option Client 220, click the Share 710, the user interface 700 may be presented. The client may then browse a image of her nails in red polish, for example, give a service rate 730 out of 10 and provide a short description 740 of her feedbacks, and click Share button 750. The information may be transmitted to the PIS 125, which may then associate the information with archives of the service providers and/or manufacturers.

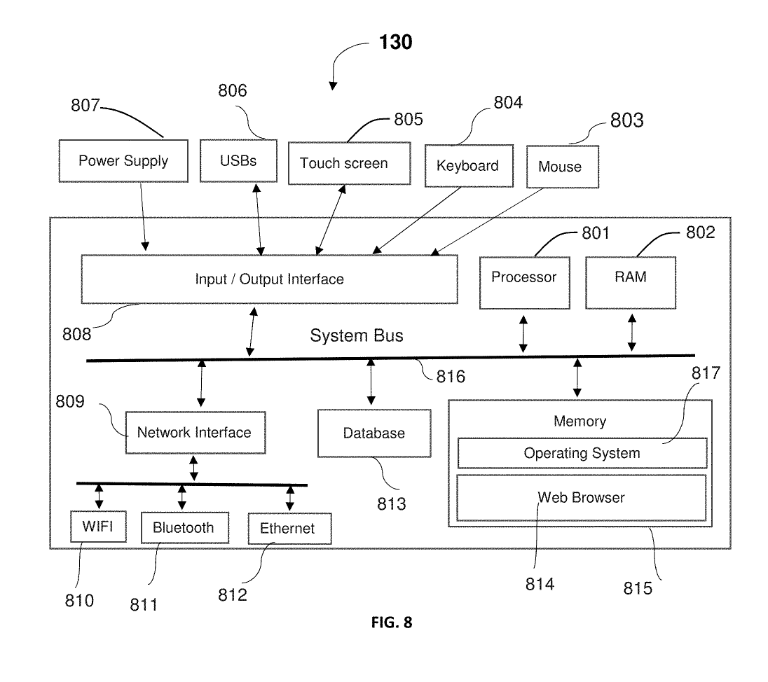

FIG. 8 provides a schematic of a workstation device 130 according to one embodiment of the present invention. As used in this embodiment, the workstation device 130 may be any computer, computing device, desktop, notebook or laptop, handheld device, or other processing device adapted to perform the functions described herein.

As shown in FIG. 8, the workstation device 130 includes a processor 801 that communicates with other elements via a system bus 816. The processor 801 may be embodied in a number of different ways. For example, the processor 801 may be embodied as various processing means such as a processing element, a microprocessor, a coprocessor, a controller, or various other processing devices including integrated circuits such as, for example, an application specific integrated circuit (“ASIC”), a field programmable gate array (“FPGA”), or another element known to those in the art. In an exemplary embodiment, the processor 801 may be configured to execute computer instructions stored in the device memory or otherwise 815 accessible to the processor 801. As such, whether configured by hardware or software methods, or by a combination thereof, the processor 801 may represent an entity capable of performing operations while configured accordingly. Input/output devices, such as Mouse 803, Keyboard 804, Touch screen 805, and USBs 806, for receiving and displaying data can also be included in the workstation device 130. Each of these I/O devices may be connected to the system bus 816 by an appropriate Input/Output interface 808. The Manager Device 800 further includes memories, which may include read only memory (ROM) and Erasable Programmable Read Only Memory (EPROM) 815, and random access memory (RAM) 802. The Memory 815 may include storage device(s) and its associated computer-readable media that may provide nonvolatile storage. The computer-readable media described could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or other implementations known in the art. Additionally, each of these storage devices may be connected to the system bus 816 by an appropriate interface.

Furthermore, a number of program modules (e.g., set of computer program instructions) may be stored by the various storage devices in Memory 815 and/or within RAM 802 and/or Database 413. Such program modules may include an operating system 817, a Database 413, and a web browser 814. The module 814 may control certain aspects of the operation of the workstation device 130 with the assistance of the processor 801 and operating system 817. The module 814 may be used to, display user interfaces 200, 300, 400, 500, 600, and 700.

Also located within the workstation device 130, in one embodiment, is a network interface 809 for interfacing with various computing elements. This communication may be via the same or different wired Ethernet 812 or wireless networks, such as WIFI 810 and Bluetooth 811 (or a combination of wired and wireless networks). For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the workstation device 130 may be configured to communicate via wireless external communication networks using any of a variety of protocols, such as 802.11, general packet radio service (“GPRS”), wideband code division multiple access (“W-CDMA”), or any other wireless protocol.

The reception devices 135 may be those of the workstation device 130. The customer device may be a smart mobile phone such as iPhone 8 or Samsung Galaxy S8. The store devices 110 may include a computer, a product scanner, and a printer. The computer contains software applications required to capture input data and sends the data to the PIS 125. The manufacturer devices 115 are computing servers interfacing with the PIS 125 via Restful API. The devices 115 can belong to the manufacturers. The polish-tracking devices 141 and sample-tracking devices 1730 may be those of the workstation device 130.

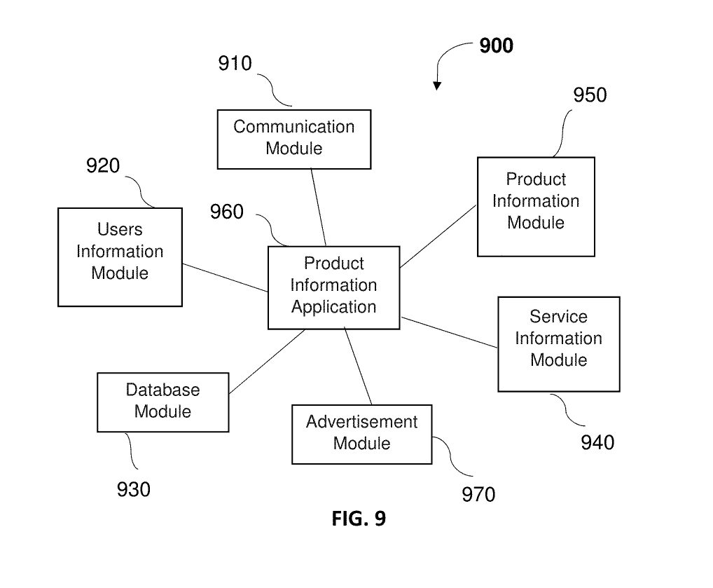

Looking now to FIG. 9 the PIS 125 may be a computing server and database devices containing databases, user interfaces, and software applications required to distribute information to all said users: customers, service providers, retailers, and manufacturers. The database devices, external and/or internal, are used to store information of products and user profiles. The workstation device 130 may be used as the server containing a database 813. In addition to the web browser 814, other software application 960 in FIG. 9 may be installed into the server. The product information application 960 may contain the following application modules: communication module 910, users information module 920, database module 930, service information module 940, product information module 950, and advertisement module 970.

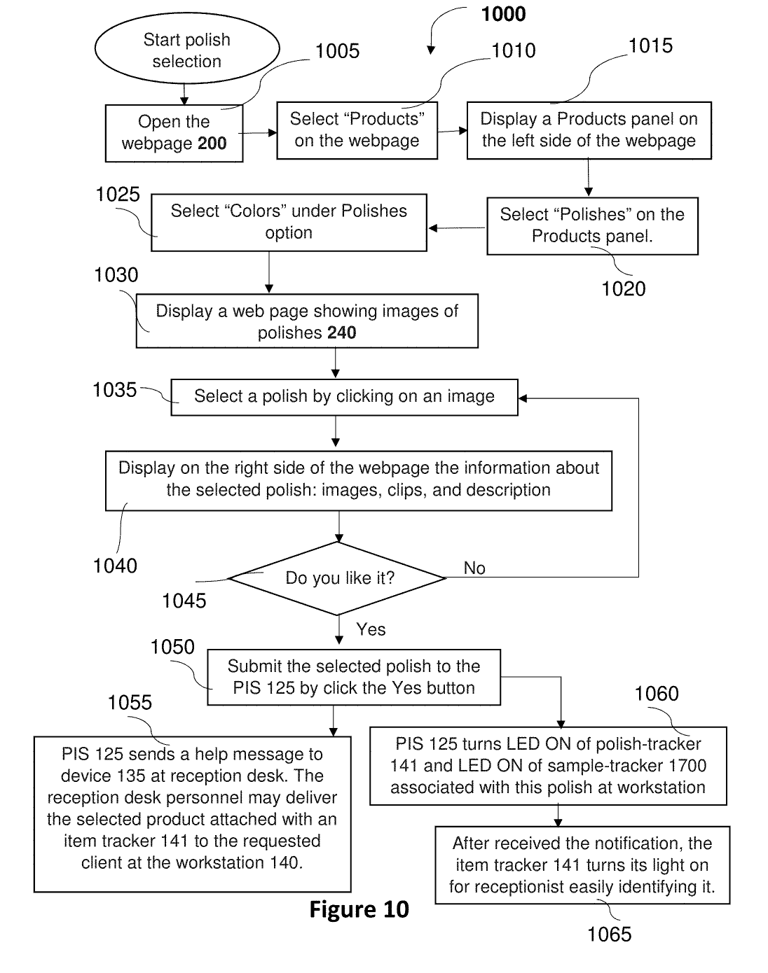

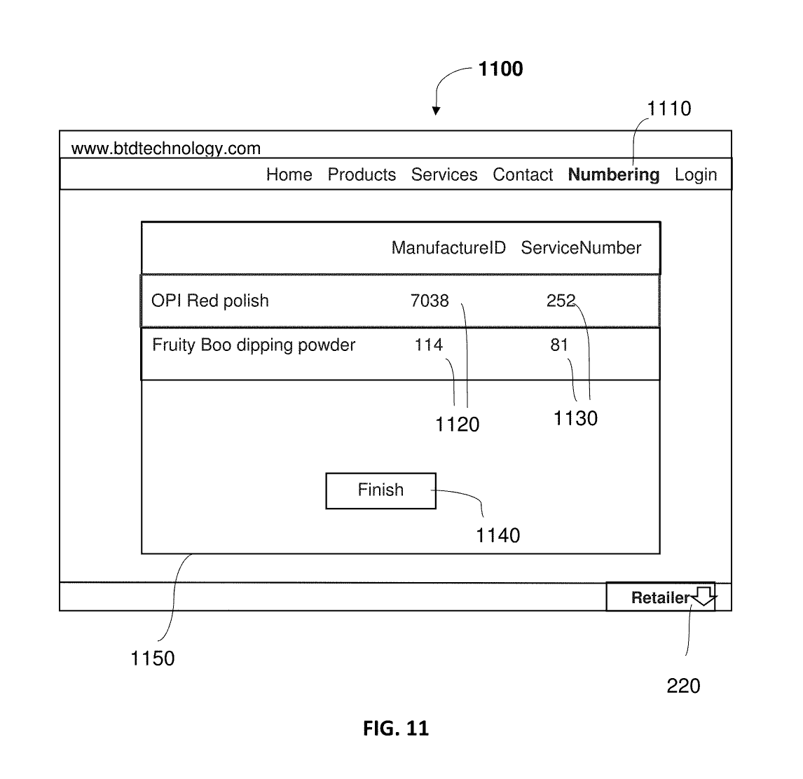

FIG. 10 shows an exemplary method according to the present disclosure. In the illustrated embodiment of FIG. 10, the steps of the method 1000 of online selecting a polish by the client currently at the workstation (130) number 8 at the nail salon 140, involve:
Step 1005: The client may type the salon's world wide web address 285 to open the webpage 200 on the workstation device 130. Then select Station 8 from the dropdown option 220.
Step 1010: select the “Products” 265 on the webpage;
Step 1015: the PIS 125 may display the Products panel 255 on the left of the webpage;
Step 1020: select the “Polishes” 270 on the Product panel;
Step 1025: then select the option “Colors” 275 below it;
Step 1030: The PIS 125 may present the panel 240 of images of polishes 235.
Step 1035: Now the customer could view all polishes available at the salon by clicking on the buttons 235.
Step 1040: Clicking on the button 235 may send a request to the PIS 125 for the information of the selected polish. The request may contain the service number 1130 (as seen in FIG. 11) of the selected polished 235. With the service number received, the PIS may look up in the database 813 the information of the selected polished with the service number and then presents the selected polish's information on box 205 for images, box 210 for video clips, and box 215 for description. She may move to the next buttons to see other polishes.
Step 1045: If the client like the selected polish, she may click the yes button 250 in step 1050.
Step 1050: Click the yes button 250, the workstation device 130 may send the help request to the PIS 125.
Step 1060: Received the help request, associated the polish with its device trackers based on service number 1130, the PIS 125 may then remotely turn ON the LED 1920 of the associated polish-tracking device 141 and remotely turn ON the LED 1750 of the associated sample-tracking device 1700. These indications help receptionist faster finding the requested polish.
Step 1055: Received the help request, the PIS 125 may then send a help message 510 to the reception desk 135, the message displayed as shown on the user interface 500 on the reception device 135. The help message 510 may provide the receptionist of the salon what the client wanted: The message may say that the client Diana A. at the workstation number 8 wanted the red OPI polish number 1234. Got the message, the receptionist may deliver the polish to the client.

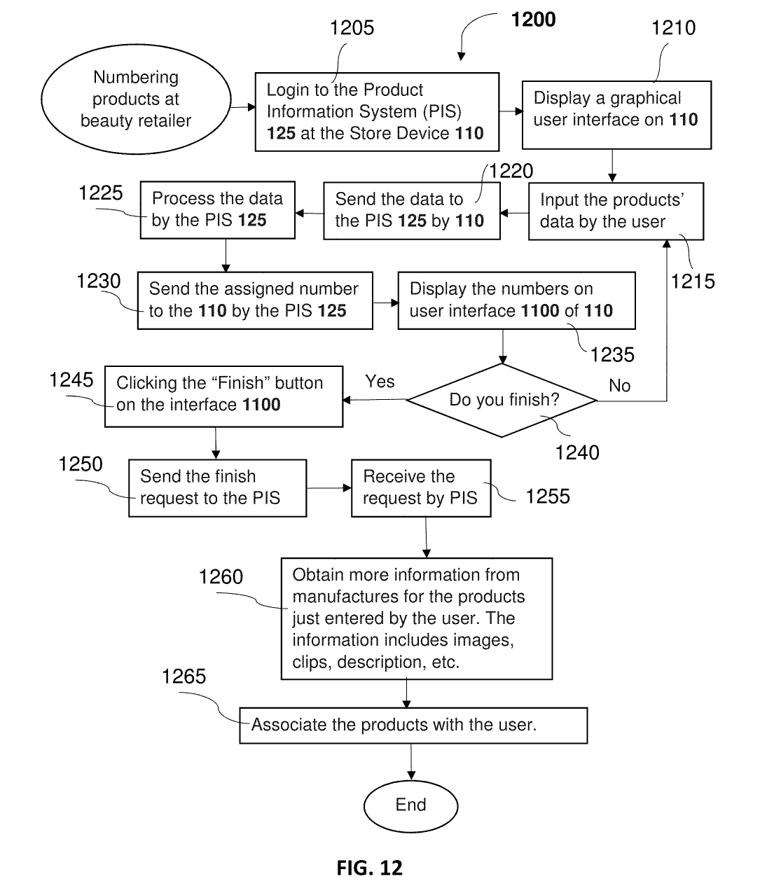

In FIG. 12, the steps of the method 1200 of numbering products by the nail service provider who is now shopping at the beauty retailer, are shown:
Step 1205: The service provider may login to the PIS 125 at the Store Device 110 at the beauty retailer. The service provider has in hand some polishes and dipping powders just bought from the retailer. Now while still at the retailer, she may identify her items by numbering them for her nail service operation.
Step 1210: Having authenticated the user, the PIS 125 may send the user interface 1100 without the numbering panel 1150 to the Store Device 110.
Step 1215: The user may input the data 1120 of the items into the user interface 1100 by scanning them.
Step 1220: Having received the input data, ManufacturelD, 1120, the Store Device 110 may send it to the PIS 125.
Step 1225: With the information of the product received, the PIS may process the data by finding out whether the product already exists. If the product exists, obtain the service number 1130 of it. If not, generate a new number for the product.
Step 1230: With the service number 1130 in hand, the PIS 125 may send it to the Store Device 110.
Step 1235: Having received the service number 1130, the Store Device 110 may display it on the service numbering panel 1150.
Step 1240: The user may continue to input data for the next item, repeat step 1215 to 1235 again.
Step 1245: When all items have been input, the user may click the finish button 1140.
Step 1250: Having received the finish request, the Store Device 110 may send it to the PIS 125.
Step 1255 and 1260: Upon receiving the finish request from the device 110, the PIS 125 may then obtain information for the items from manufacturers. To obtain the information, the PIS may make a request to the Manufacturer Device 115 using internet protocol interface API such as Restful. In an embodiment, the information is already stored in a memory device such as USB stick and/or database. Then the PIS may obtain the information from there. In an embodiment, the manufactures had already send the information to the PIS previously and it is stored in the PIS's database.
Step 1265: After obtained the information, the PIS 125 may then associate the information with an archive of the user. This means the information of the products just bought by the user may be saved in a computing device, database, and/or server belong to the user. The PIS may also link the information to the buttons 235 in FIG. 2, so when the client clicks on the button, this information of these products may be presented in the boxes 205, 210, and 215.

In addition, method 1200 may be used for shopping online; in that case the input data in step 1215 may not needed. As a result, the service providers may receive the products with service numbers printed on them. In this case, the online suppliers have access to the buyers' PIS 125.

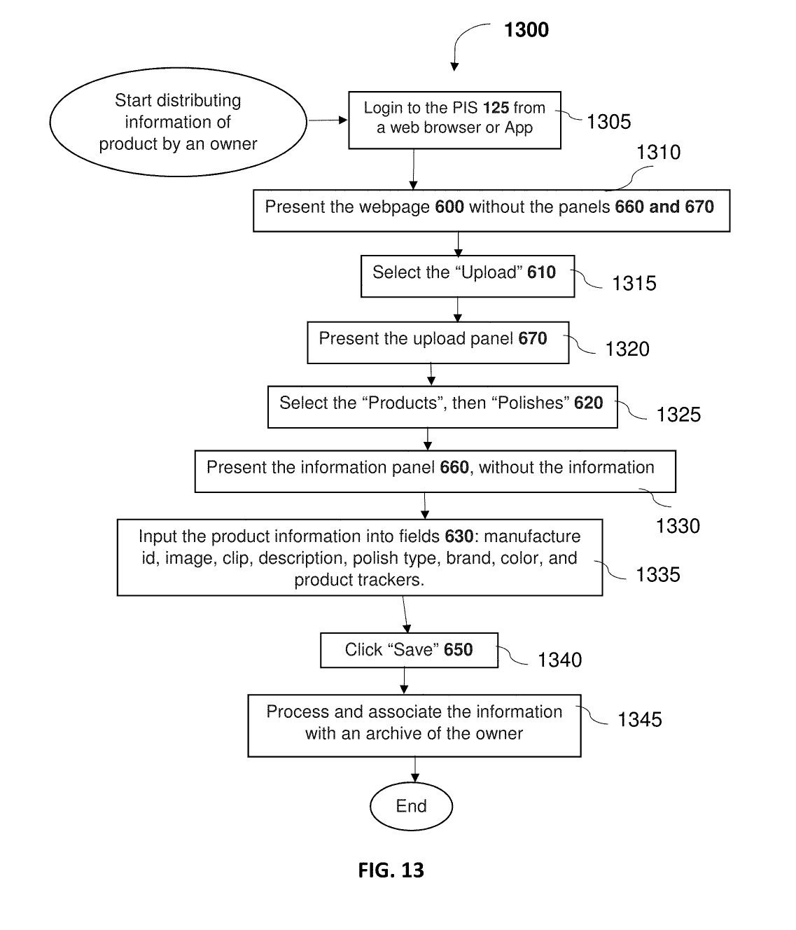

Looking now to FIG. 13 a method 1300 of manually uploading information of products and their trackers by the service providers, is shown. The nail service provider may perform this method at their workplace 140 using the Reception Device 135. Actually, they may perform the method anywhere as long as they have access to computer and internet network 120 available. They may use the smart mobile phone with an App installed written in Android or iOS or React Native, instead of using web browser, if they wanted to use the App to do the work. The method may be based on the user interface 600 in FIG. 6.
Step 1305: Open a web browser, the owner logins into the PIS 125 from the reception device 135.
Step 1310: Validating the user credentials received from the reception device 135, the PIS presents the webpage 600 without the panels 660 and 670. These panels are displayed in later steps.
Steps 1315, 1320, and 1325: The user continues by clicking the “Upload” 610 on the top bar of the page. The PIS 125 then presents the upload panel 670 on the left of the page 600. The user then continues selecting “Products” and “Polishes” 620.
Step 1330: the PIS 125 sends the data panel 630 in digital form to the Reception Device 135 for presenting the data as shown in panel 630.
Step 1335 and 1340: With the fields provided, the owner now may enter the information of the product she wanted to upload to the PIS 125 for her business: brand, color, manufacture identification, image, video clip, and description and product trackers (polish-tracking device 141 and sample-tracking device 1730). And then click the “Save” button 650 to submit the information to the PIS 125.
Step 1345: Upon the receiving the information, the PIS 125 may process it and associate the information with an archive of the owner. The PIS may also link the information to the red button 235 in FIG. 2 and its associated trackers (polish-tracking device 141 and sample-tracking device 1730), so when the client clicks on the button, this information of this product may be presented in the boxes 205, 210, and 215.

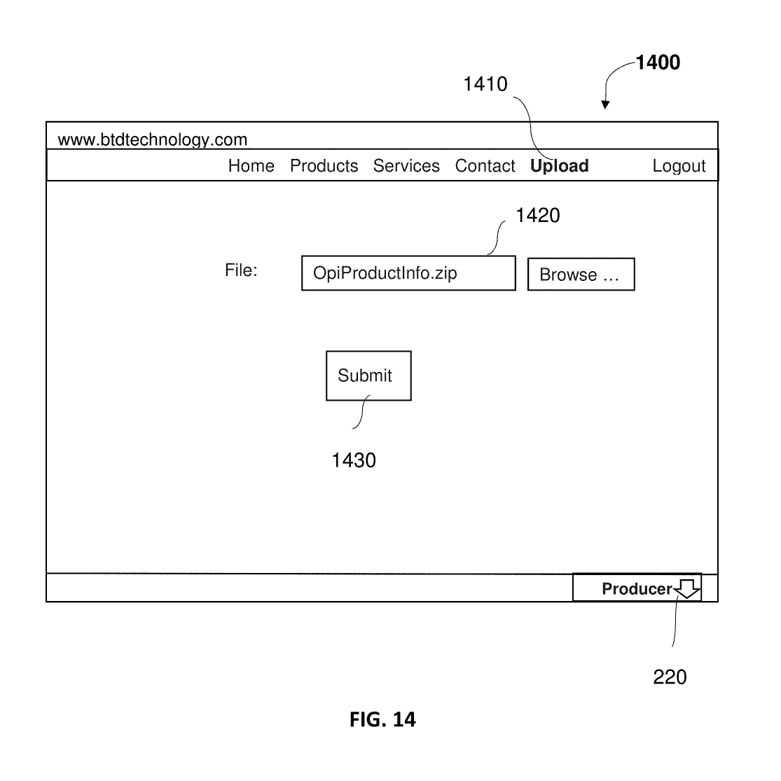

In FIGS. 14 & 15 a method and associated interface are shown. In particular, the steps of the method 1500 of uploading information of products by the manufactures, are show. The manufacturers may have accounts with the PIS 125, so they may distribute their products information from their plants (Manufacturer Device 115) to the customers (via service providers) easily. Same for the retailers, according to an embodiment. In another embodiment, they may in this way distribute advertisements and/or information of future products. The user interface 1400 shown in FIG. 14, may be used for this method.
Step 1510: Open a web browser, the manufacture logs into the PIS 125 from the manufacture device 115.
Step 1520: Validating the user credentials received from the manufacture device 115, the PIS then sends data for the webpage 1400, without the input field 1420 and the submit button 1430, which are displayed in the next step.
Step 1530: Having received the data for a webpage, the manufacture device 115 then presents it as shown in the user interface 1400, including the input field 1420 for a file of product information and the submit button 1430 to upload the file to the PIS 125.
Steps 1540 and 1550: The manufacturer then browses for a zip file 1420 containing information of products. To upload the file to the PIS 125, the user may just click the “Submit” button 1430.
Step 1560: Upon receiving the file, the PIS 125 may then process it and associate the information from the file with archives of the service providers. The PIS may also link the information to the buttons 235 in FIG. 2, so when the clients click on the buttons, the information of products may be presented in the boxes 205, 210, and 215.

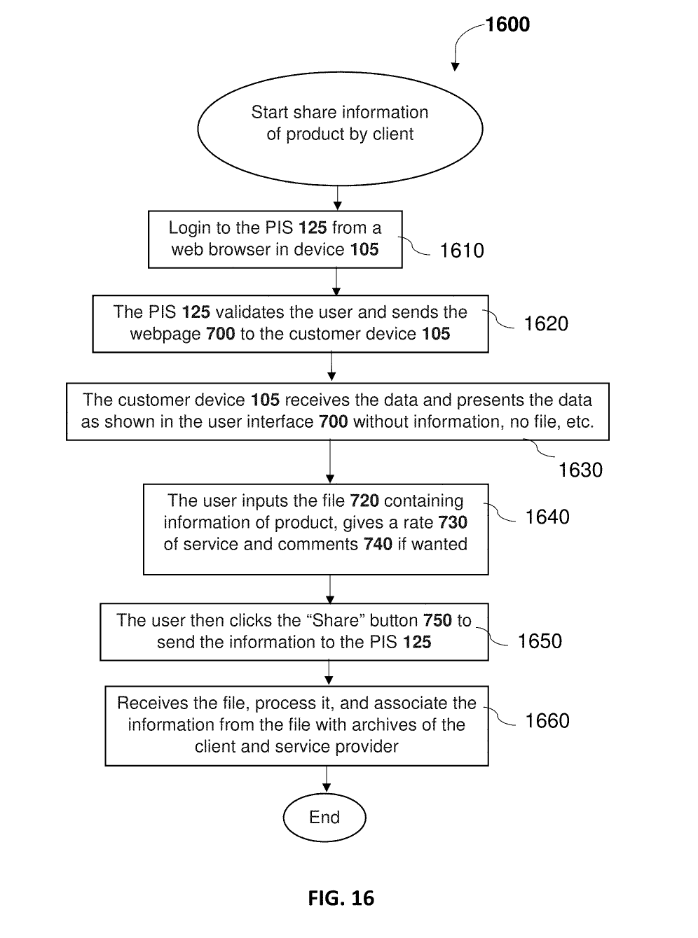

Looking to FIG. 16 method 1600 for sharing information of products by the clients of nail service providers, is shown. The clients may have accounts with the PIS 125, so they may share their experience of using products from their device (Customer Device 105) to other clients, service providers, and/or manufacturers easily. In another embodiment, they may in this way share their feedbacks. The user interface 700 in FIG. 7, may be used for this method.
Step 1610: Open a web browser, the client logs into the PIS 125 from the customer device 105.
Step 1620: Validating the user credentials received from the customer device 105, the PIS then sends data for the webpage 700, without the input fields 720, 730 and 740; and the share button 750, which are displayed in the next step.
Step 1630: Received the data for a webpage, the customer device 105 then presents it as shown in the user interface 700 without file, rate and comments, including the input fields 720 for a file of product information, 730 for rate, and 740 for comments; and the submit button 750 to upload the data to the PIS 125.
Steps 1640 and 1650: Now the client may browse for an image file 720 of her nails. If wanted but not required, she may give a rate 730 for her service provider and provide comments 740. To upload the file to the PIS 125, the user may just click the “Share” button 750.
Step 1660: Upon receiving the file, the PIS 125 may then process it and associate the information from the file with archives of the client and the service provider. The PIS may also link the information to the buttons 235 in FIG. 2, so when the clients click on the buttons, the information of products may be presented in the boxes 205, 210, and 215. The PIS may also share the file with other clients.

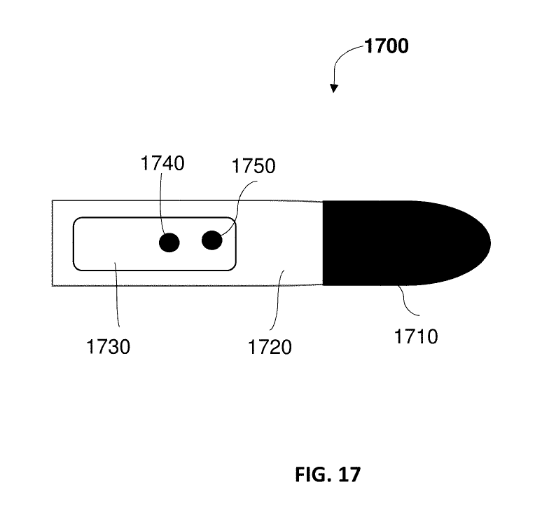

Looking now to FIG. 17, there is shown a product sample attached to a sample-tracking device 1730, including painted sample 1710. Samples are used for polishes, dipping powders, no chip gel, etc. and used by customers for making selection.

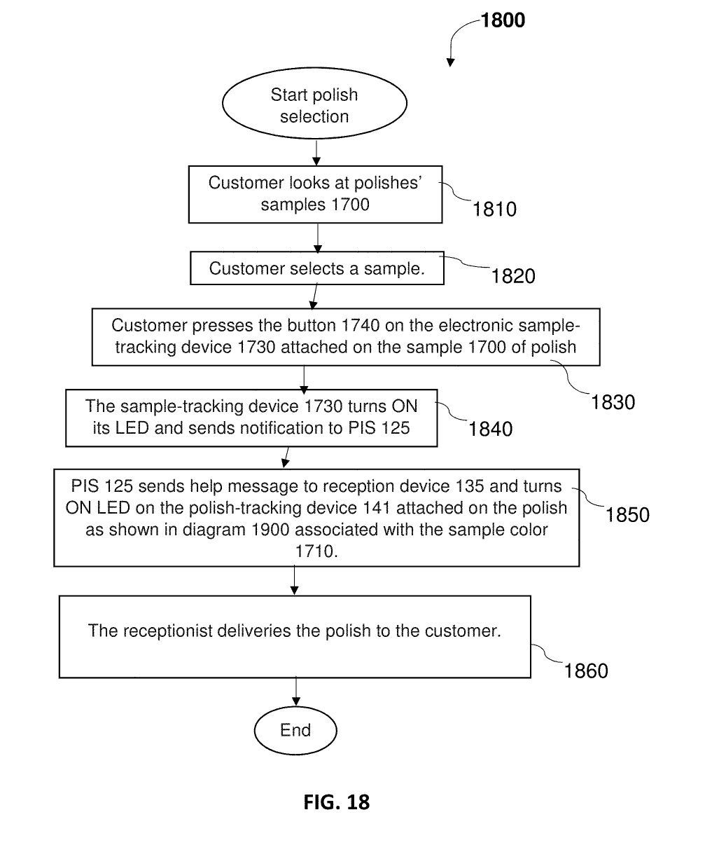

FIG. 18 shows an exemplary method according to the present disclosure. In the illustrated embodiment of FIG. 18, the steps of the method 1800 of selecting a polish by the client currently at salon, involve:
Step 1810: The client may in hand hold samples 1700 of polishes and scan through those samples for a desired color.
Step 1820: The client may select a sample for the polish she wanted.
Step 1830: To get the selected polish, the client may then press the button 1740 on the sample-tracking device 1730 attached on the sample 1700.
Step 1840: The sample-tracking device 1730 may turn ON its LED 1750 (to indicate its location for receptionist) and send a notification containing polish identification (Service number 1130) to the PIS 125.
Step 1850: Received the notification from the sample tracker, the PIS 125 may send a help message to reception device 135 and may turn ON Led on the polish-tracking device 141 to indicate the polish's location for receptionist.
Step 1860: Read the help message on reception device 135, the receptionist may look on displays for led light from the polish-tracking device, take the polish, and delivery it to the customer who has the sample-tracking device with LED ON. LED color may be used to differentiate customers if more than ones pressed buttons on sample-tracking devices at the same time. (LED colors of polish tracker and sample tracker are same.)

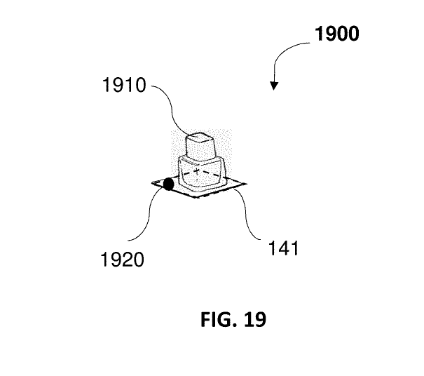

Finally, looking now to FIG. 19, there is shown a product tracking device 141 attached to a polish. These product tracking devices are attached to polishes, dipping powder, no chip gel, etc. for improving business operations of nail salons, cutting times spent looking for products.

### INDUSTRIAL APPLICABILITY AND CONSTRUCTION

In an aspect of the present disclosure may be implemented in various ways, including as methods, apparatuses, systems, or computer program products.

As will be appreciated by those skilled in the art, the embodiments of the present invention may be implemented in various ways, including as methods, apparatuses, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CDROMs, optical storage devices, or magnetic storage devices.

Particular embodiments are described herein with reference to block diagrams and flowchart illustrations of methods, apparatus, systems, and computer program application products. It should be understood that each block of the block diagrams and flowchart illustrations, respectively, may be implemented in part by computer program instructions (e.g., as logical steps or operations executing on a processor in a computing system). These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner such that the instructions stored in the computer readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

These computer program instructions or codes for carrying out methods or operations for aspects of the present invention may be written in any combination of one or more programming languages, including an object oriented programming language such as Java, C++, C# or the like and conventional procedural programming languages, such as C or similar ones. The computer program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, as well as combinations of blocks in the block diagrams and flowchart illustrations, can be implemented by special purpose hardware-based computer systems that perform the specified functions or operations, or combinations of special purpose hardware and computer instructions.

The terminology used herein is for the purpose of describing particular example embodiments only and is not intended to be limiting. The method steps, processes, and operations described herein are not to be construed as necessarily requiring their performance in the particular order discussed or illustrated, unless specifically identified as an order of performance. It is also to be understood that additional or alternative steps may be employed.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A system for distributing products information comprising:
a product information system;
a network connected to the product information system, the network connected to customer devices, store devices, manufacturer devices and at least one workplace;
wherein product information is transmitted from the customer devices, store devices, and manufacturer devices to the product information system through the network;
wherein the product information system is in communication with the at least one workplace, the at least one workplace having at least one workstation device; and
wherein the at least one workstation device is capable of displaying and interacting with the processed product information.

2. The system of claim 1 wherein:
the at least one workstation device comprises a user interface with the support of a web browser or mobile application, the web browser or mobile application connected to a product information application contained within the product information system;
wherein the user interface provides information on products.

3. The system of claim 2 wherein:
the user interface displays online a selection of products and contains individualized buttons for products.

4. The system of claim 3 wherein:
the selection of products is chosen from a list consisting of: Polishes, Colors, and Brands.

5. The system of claim 1 wherein:
store devices contain a service user interface, the service user interface allowing a user to upload information related to a set of products;
wherein the service user interface allows saving the information to the product information system.

6. The system of claim 5 wherein:
the information about products a user may upload is selected from the list consisting of: type, brand, color, id, and description.

7. The system of claim 1 wherein:
store devices, manufacturer devices, and client devices upload product information to the product information system automatically, without user interface.

8. A method for distributing products information comprising:
opening a webpage or app on a device;
selecting a station;
selecting a product on the products panel; thereby
distributing products information to a customer.

9. The method of claim 8 further comprising:
select the option “Colors”;
presenting a panel images;
displaying information about a selected product;
submitting a confirmation to the product information system;
sending a help message, via the product information system to a help desk, the help message displaying the selected product;
activate selected product location indications, via the product information system to product-tracking devices, the indications at business space be ringing, flashing, or vibrating.

10. The method of claim 9 further comprising:
delivering the selected product to service location.

11. The method of claim 10 wherein the products panel displays polishes.

12. The method of claim 9 wherein:
the help message contains client information, and said client information is also stored and saved in the product information system.

13. The method of claim 9 wherein:
information about the selected product includes at least a manufacturing identification number and a service identification number.

13. A method for receiving a product comprising:
opening a webpage or app on a device;
selecting a station number;
selecting a product on a products panel, the products panel located on the webpage or app; thereby
activating product trackers's indication and delivering a product to a client.

14. The method for receiving a product of claim 13 further comrising:
selecting a sample of a product;
activating product tracker on the sample; thereby
delivering a product to the client
